(19) United States
(12) Patent Application Publication
(10) Pub. No.: US 2025/0329108 A1
(43) Pub. Date: Oct. 23, 2025

(54) INTERACTIVE MEDIA CONTENT WITHIN VIRTUAL EXPERIENCES

(71) Applicant: Roblox Corporation, San Mateo, CA (US)

(72) Inventors: Richard SIM, San Mateo, CA (US); Sari ABUKHADRA, Foster City, CA (US); Justin ANDERSON, San Mateo, CA (US)

(73) Assignee: Roblox Corporation, San Mateo, CA (US)

(21) Appl. No.: 19/180,009

(22) Filed: Apr. 15, 2025

Related U.S. Application Data
(60) Provisional application No. 63/634,066, filed on Apr. 15, 2024.

(51) Int. Cl. G06T 17/00; A63F 13/5258; A63F 13/54; H04N 21/4784; H04N 21/485

(52) U.S. Cl. CPC G06T 17/00; A63F 13/5258; A63F 13/54; H04N 21/4784; H04N 21/4852

(57) ABSTRACT

Various implementations relate to methods, systems, and computer-readable media for presenting media within a virtual experience based on user interaction. According to one aspect, a computer-implemented method includes receiving media associated with a target demographic. A determination is made that one or more viewability criteria are satisfied based on a perspective of an avatar associated with a user relative to a digital media display element, and that a level of interest of the user meets a threshold level based on interest criteria. In response, presentation of the media is initiated by displaying video content and playing back mixed spatial audio comprising both media audio and virtual experience audio. Interactive controls are provided. User input and avatar engagement are obtained, and an engagement metric is generated based on the collected input and engagement.

### CROSS-REFERENCE TO RELATED APPLICATIONS

This application claims priority to U.S. Provisional Patent Application No. 63/634,066, filed Apr. 15, 2024, and titled “INTERACTIVE DIGITAL VIDEO ADVERTISING WITHIN VIRTUAL EXPERIENCES,” the entire contents of which are incorporated by reference herein.

### TECHNICAL FIELD

Embodiments relate generally to online virtual experience platforms, and more particularly, to methods, systems, and computer readable media for presenting digital media within virtual experiences.

### BACKGROUND

In virtual experience platforms, users participate in immersive three-dimensional (3D) environments where they interact with other users, content, and programmable objects. As part of these environments media elements-such as video panels, interactive screens, or spatial audio sources-can be embedded within the virtual space. These media elements may serve entertainment, educational, and/or promotional purposes and are often integrated into the world to blend with gameplay or user activity. Current approaches for media presentation in these environments are generally adapted from legacy two-dimensional approaches that do not account for spatial context, user behavior, or the immersive nature of 3D interaction.

In traditional internet applications, media playback is often triggered based on simple visibility or loading events, such as whether an element is present within a viewport. In 3D environments, such binary conditions fail to account for the complexity of user perspective, motion, occlusion, or gaze alignment. As a result, media may play even when the user is not actively engaging with it, leading to degraded user experience, unnecessary resource usage, and unreliable performance metrics. For example, video content of the media might begin playback solely because a user's avatar in a 3D environment passes near a media surface, even if the media is not visible or relevant to the behavior of the user at that time.

Furthermore, existing media playback approaches on virtual platforms may present a default that is neither timely nor contextually appropriate to the user. Such media playback can interrupt immersion in the 3D environment, distract from ongoing interaction, and fail to connect meaningfully with the user.

Audio playback in 3D virtual environments presents another set of challenges. Most conventional approaches do not support dynamic audio mixing (including mixing that is aware of spatial attributes of the audio) in a way that balances the media audio with surrounding environmental sounds, voice chat, or gameplay effects. Media audio may overpower ambient noise or, conversely, may be difficult to hear due to overlapping sounds. In multi-user scenarios, this degrades both individual experience and social interaction within the virtual space.

Additionally, current platforms may obtain metrics such as view duration that do not adequately reflect how users respond to media content within a 3D environment.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

Aspects of this disclosure are directed to methods, systems, and computer readable media to present digital media within virtual experiences.

In one aspect, a computer-implemented method to present media within a virtual experience provided by a virtual experience platform is disclosed, including: receiving media configured for display within the virtual experience, the media associated with a target demographic. The computer-implemented method further includes determining that one or more viewability criteria are satisfied based on a perspective of an avatar associated with a user relative to a digital media display element positioned within the virtual experience, where the user is associated with the target demographic. The computer-implemented method further includes determining, based on one or more level of interest criteria, that a level of interest of the user to view the media meets a threshold level. In response to determining that the one or more viewability criteria are satisfied and determining that the level of interest meets the threshold level, the computer-implemented method further includes initiating presentation of the media within the virtual experience by displaying video content of the media at the digital media display element, and playing back mixed spatial audio, where the mixed spatial audio includes at least audio content of the media and audio from the virtual experience. The computer-implemented method further includes providing interactive controls to modify the presentation of the media, the interactive controls including at least a full-screen activation control. The computer-implemented method further includes obtaining user input associated with the interactive controls and engagement by the avatar with the digital media display element. The computer-implemented method further includes generating an engagement metric for the media based on the user input and the engagement by the avatar.

In some implementations, the one or more level of interest criteria include one or more from the group including: a dwell time of the avatar within a proximity threshold of the digital media display element, a sustained orientation of the avatar or in-game camera toward the digital media display element, a raycast-based unobstructed line of sight to the digital media display element, a duration of screen-center alignment with the digital media display element, and any combination thereof.

In some implementations, determining the level of interest of the user includes evaluating a cumulative level of interest score computed from multiple level of interest criteria.

In some implementations, prior to determining that the one or more viewability criteria are satisfied and determining the level of interest of the user to view the media, a non-playing visual frame of the media is displayed in the digital media display element.

In some implementations, presenting the media includes initially rendering the video content of the media in a muted state and enabling audio playback in response to detecting a user interaction with the digital media display element.

In some implementations, the computer-implemented method further includes, upon the full-screen activation control being triggered by user input, interpolating a virtual camera associated with the avatar toward the digital media display element while preserving peripheral visibility of the virtual experience.

In some implementations, the computer-implemented method further includes, after initiating presentation of the media within the virtual experience, detecting that at least one of the viewability criteria or the level of interest criteria is not satisfied, and in response to the detecting, pausing playback of the media.

In some implementations, the computer-implemented method further includes resuming playback of the video content of the media when the at least one of the viewability criteria or the level of interest criteria is re-satisfied.

In some implementations, generating the engagement metric for the media includes measuring one or more from the group including: a total duration of playback, a completion status of the video content of the media, one or more transitions between presentation modes, and any combination thereof.

In some implementations, the computer-implemented method further includes granting a virtual reward to the user upon completion of playback of the media within the virtual experience and upon the engagement metric generated for the media meeting a predefined engagement threshold, where the virtual reward is specified by one of: a developer of the virtual experience, or a media provider associated with the media.

In some implementations, the media includes one or more from the group including: video content of the media, still images, holographic content, special effects, animated visual elements, and combinations thereof.

In some implementations, the computer-implemented method further includes applying access control rules to restrict display of the media based on one or more from the group including: one or more user attributes, an experience type of the virtual experience, one or more developer restrictions specified by a developer of the virtual experience, one or more media provider policies of a media provider associated with the media, and any combination thereof.

In some implementations, the computer-implemented method further includes generating the mixed spatial audio by applying audio mixing logic to dynamically adjust, based on a media presentation mode, one or more properties of the audio content of the media and the audio from the virtual experience, wherein the one or more properties include audio volume levels, audio directionality, and combinations thereof.

In some implementations, applying the audio mixing logic includes dynamically lowering playback volume of in-game voice chat such that the playback volume of the in-game voice chat is lower than a playback volume of the audio associated with the video content of the media.

According to another aspect, a system includes one or more processors and memory coupled to the one or more processors storing instructions that, when executed by the one or more processors, cause the one or more processors to perform operations including: receiving media configured for display within a virtual experience, the media associated with a target demographic; determining that one or more viewability criteria are satisfied based on a perspective of an avatar associated with a user relative to a digital media display element positioned within the virtual experience, where the user is associated with the target demographic; determining, based on one or more level of interest criteria, that a level of interest of the user to view the media meets a threshold level; in response to determining that the one or more viewability criteria are satisfied and determining that the level of interest meets the threshold level, initiating presentation of the media within the virtual experience by displaying video content of the media at the digital media display clement, and playing back mixed spatial audio, where the mixed spatial audio includes at least audio content of the media and audio from the virtual experience; providing interactive controls to modify the presentation of the media, the interactive controls including at least a full-screen activation control; obtaining user input associated with the interactive controls and engagement by the avatar with the digital media display element; and generating an engagement metric for the media based on the user input and the engagement by the avatar.

In some implementations, the operations further include adjusting, based on the engagement metric, one or more parameters used to determine the level of interest of users in the media, where the adjusting includes increasing or decreasing a weight assigned to one or more level of interest criteria for future users, thereby reducing resource usage by limiting presentation of media with low predicted engagement.

In some implementations, the operations further include providing a reward to at least one of a creator of the virtual experience or a provider of the media based on the engagement metric exceeding a predefined threshold.

In some implementations, the media is associated with multiple target demographics, where generating the engagement metric includes generating separate engagement metrics for each of the target demographics, and where the operations further include providing the separate engagement metrics as feedback to an entity associated with the media for evaluation of demographic-specific performance.

In some implementations, the operations further include receiving a bid specification from a media provider, the bid specification defining one or more bidding conditions based on one or more from the group including: a bid per user determined to meet at least a threshold level of interest in the media based on the level of interest criteria, a bid per user determined to have at least a threshold level of engagement with the media based on the engagement metric, a bid per user who views the media for at least a specified duration, and any combination thereof.

According to another aspect, a non-transitory computer-readable medium with instructions stored thereon is provided that, when executed by a processor, cause the processor to perform operations. The operations include: receiving media configured for display within a virtual experience, the media associated with a target demographic; determining that one or more viewability criteria are satisfied based on a perspective of an avatar associated with a user relative to a digital media display clement positioned within the virtual experience, where the user is associated with the target demographic; determining, based on one or more level of interest criteria, that a level of interest of the user to view the media meets a threshold level; in response to determining that the one or more viewability criteria are satisfied and determining that the level of interest meets the threshold level, initiating presentation of the media within the virtual experience by displaying video content of the media at the digital media display element, and playing back mixed spatial audio, where the mixed spatial audio includes at least audio content of the media and audio from the virtual experience; providing interactive controls to modify the presentation of the media; obtaining user input associated with the interactive controls and engagement by the avatar with the digital media display element; and generating an engagement metric for the media based on the user input and the engagement by the avatar.

According to yet another aspect, portions, features, and implementation details of the systems, apparatuses, devices, methods, and non-transitory computer-readable media may be combined to form additional aspects, including some aspects which omit and/or modify some or portions of individual components or features, include additional components or features, and/or other modifications; and all such modifications are within the scope of this disclosure.

### BRIEF DESCRIPTION OF DRAWINGS

FIG. 1 is a diagram of an example network environment, in accordance with some implementations.

FIG. 2 is a diagram of an example system architecture to present digital media within a virtual experience, in accordance with some implementations.

FIG. 3A is a perspective view of a digital media display element, in accordance with some implementations.

FIG. 3B is a diagram illustrating multiple avatars viewing respective digital media display elements, in accordance with some implementations.

FIG. 4A is a perspective view of a digital media display element, in accordance with some implementations.

FIG. 4B is a diagram illustrating an avatar viewing digital media, in accordance with some implementations.

FIG. 5 is a flowchart of an example method to present digital media within a virtual experience, in accordance with some implementations.

FIG. 6A is a diagram illustrating an example user interface view displaying evaluation results for viewability criteria, in accordance with some embodiments.

FIG. 6B is a diagram illustrating an example user interface view displaying evaluation results for viewability criteria associated with a digital media display element that is partially obstructed, in accordance with some embodiments.

FIG. 7 is a block diagram illustrating an example computing device, in accordance with some implementations.

### DETAILED DESCRIPTION

In the following detailed description, reference is made to the accompanying drawings, which form a part hereof. In the drawings, similar symbols identify similar components, unless context dictates otherwise. The illustrative implementations described in the detailed description, drawings, and claims are not meant to be limiting. Other implementations may be utilized, and other changes may be made, without departing from the spirit or scope of the subject matter presented herein. Aspects of the present disclosure, as generally described herein, and illustrated in the Figures, can be arranged, substituted, combined, separated, and designed in a wide variety of different configurations, all of which are contemplated herein.

References in the specification to “some implementations”, “an implementation”, “an example implementation”, etc. indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, such feature, structure, or characteristic may be effected in connection with other implementations whether or not explicitly described.

In some aspects, systems and methods are provided to present interactive digital media within a virtual experience. Online platforms, such as online virtual experience platforms, generally provide the ability to create, store, present, and promote virtual items to be used in virtual experiences.

For example, virtual experience platforms may include user-generated content or developer-generated content (each referred to as UGC herein). The UGC may be stored and surfaced through the virtual experience platform, for example, by enabling users to search and interact with various virtual experiences and associated virtual items. Virtual items may be presented in a search interface or inventory screen, enabling users to browse, discover, and purchase items prior to or during participation in a virtual experience.

While search interfaces and inventory screens enable users to search for items, virtual experiences provide a more immersive environment. Within these environments, avatars may navigate through the virtual space and interact with a variety of elements, including virtual items and other users.

Example embodiments may provide interactive media, such as videos with audio, still images, holographic content, or special effects, rendered within a virtual experience and capable of tracking engagement at a per-user level. Engagement data may support various models of value distribution, including payments from media providers based on presentation or engagement thresholds.

According to implementations described herein, a virtual experience platform may deploy a media presentation component at a server and deliver interactive media within one or more virtual experiences. The component may use user-permitted data and behavioral context to initiate presentation of media in a manner tailored to user demographics and determined level of interest. Media presentation may be initiated only when one or more viewability criteria are satisfied and a determined level of interest—based on defined level of interest criteria—is met. Multiple avatars may simultaneously be presented with distinct media through individual digital media display elements, such that media of one user is not necessarily visible to others. This enables concurrent presentation of personalized media across users, with tracking and analysis of user input and avatar engagement to compute engagement metrics. These metrics may inform decisions such as adaptive media presentation, media selection, and reward allocation. Additional embodiments and variations will be described in detail throughout this disclosure.

It is noted that any use of user and/or developer data to determine interests of users, identify matching items, or any other purpose is specifically with permission from the user, in accordance with applicable regulations, and can be turned off by the user. Users can choose what data to permit for such use. User data is stored securely and in compliance with rules and laws. Furthermore, data collection is not performed in certain geographic locales, for certain user categories (e.g., based on age or other demographic), is temporary (data are discarded after a period of time), and data is stored securely even when only used temporarily. Moreover, user data are not shared with third-parties without explicit user permission. Even further, some data may be anonymized, aggregated across users, or otherwise modified so that a specific user identity cannot be determined.

Hereinafter, further details surrounding example embodiments and various aspects of this disclosure are described with reference to the figures.

### System Architecture

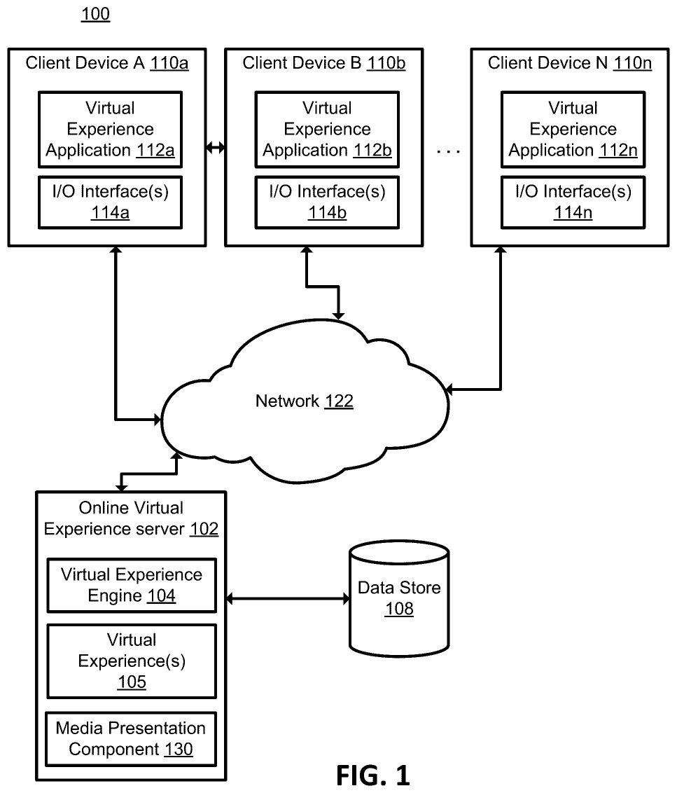

FIG. 1 illustrates an example network environment 100, in accordance with some implementations of the disclosure. FIG. 1 and the other figures use like reference numerals to identify like elements. A letter after a reference numeral, such as “110a,” indicates that the text refers specifically to the element having that particular reference numeral. A reference numeral in the text without a following letter, such as “110,” may include any or all of the elements in the figures bearing that reference numeral (e.g., “110” in the text may include reference numerals “110a,” “110b,” and/or “110n” in the figures).

The network environment 100 (also referred to as a platform herein) includes an online virtual experience server 102, a data store 108, a client device 110 (or multiple client devices), and a third party server 118, all coupled via a network 122.

The online virtual experience server 102 can include, among other things, a virtual experience engine 104, one or more virtual experiences 105, and a media presentation component 130. The online virtual experience server 102 may be configured to provide virtual experiences 105 to one or more client devices 110, and to provide interactive digital media via the media presentation component 130, in some implementations.

Data store 108 is shown coupled to online virtual experience server 102 but in some implementations, can be provided as part of the online virtual experience server 102. The data store may, in some implementations, be configured to store media, user data, engagement data, and/or other contextual data in association with the media presentation component 130.

The client devices 110 (e.g., 110a, 110b, 110n) can include a virtual experience application 112 (e.g., 112a, 112b, 112n) and an I/O interface 114 (e.g., 114a, 114b, 114n), to interact with the online virtual experience server 102, and to view, for example, graphical user interfaces (GUI) through a computer monitor or display (not illustrated). In some implementations, the client devices 110 may be configured to execute and display virtual experiences, which may include media elements as described herein.

Network environment 100 is provided for illustration. In some implementations, the network environment 100 may include the same, fewer, more, or different elements configured in the same or different manner as that shown in FIG. 1.

In some implementations, network 122 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a Long Term Evolution (LTE) network), routers, hubs, switches, server computers, or a combination thereof.

In some implementations, the data store 108 may be a non-transitory computer readable memory (e.g., random access memory), a cache, a drive (e.g., a hard drive), a flash drive, a database system, or another type of component or device capable of storing data. The data store 108 may include multiple storage components (e.g., multiple drives or multiple databases) that may span multiple computing devices (e.g., multiple server computers).

In some implementations, the online virtual experience server 102 can include a server having one or more computing devices (e.g., a cloud computing system, a rackmount server, a server computer, cluster of physical servers, virtual server, etc.). In some implementations, a server may be included in the online virtual experience server 102, be an independent system, or be part of another system or platform. In some implementations, the online virtual experience server 102 may be a single server, or any combination a plurality of servers, load balancers, network devices, and other components. The online virtual experience server 102 may be implemented on physical servers, but may utilize virtualization technology, in some implementations. Other variations of the online virtual experience server 102 are applicable.

In some implementations, the online virtual experience server 102 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the online virtual experience server 102 and to provide a user (e.g., user 114 via client device 110) with access to online virtual experience server 102.

The online virtual experience server 102 may include a website (e.g., one or more web pages) or application back-end software that may be used to provide a user with access to content provided by online virtual experience server 102. For example, users (or developers) may access online virtual experience server 102 using the virtual experience application 112 on client device 110, respectively.

In some implementations, online virtual experience server 102 may include digital asset and digital virtual experience generation provisions. For example, the platform may provide administrator interfaces enabling the design, modification, unique tailoring for individuals, and other modification functions. In some implementations, virtual experiences may include two-dimensional (2D) games, three-dimensional (3D) games, virtual reality (VR) games, or augmented reality (AR) games, for example. In some implementations, virtual experience creators and/or developers may search for virtual experiences, combine portions of virtual experiences, tailor virtual experiences for particular activities (e.g., group virtual experiences), and other features provided through the virtual experience server 102.

In some implementations, online virtual experience server 102 or client device 110 may include the virtual experience engine 104 or virtual experience application 112. In some implementations, virtual experience engine 104 may be used for the development or execution of virtual experiences 105. For example, virtual experience engine 104 may include a rendering engine (renderer) for 2D, 3D, VR, or AR graphics, a physics engine, a collision detection engine (and collision response), sound engine, scripting functionality, haptics engine, artificial intelligence engine, networking functionality, streaming functionality, memory management functionality, threading functionality, scene graph functionality, or video support for cinematics, among other features. The components of the virtual experience engine 104 may generate commands that help compute and render the virtual experience (e.g., rendering commands, collision commands, physics commands, etc.).

The online virtual experience server 102 using virtual experience engine 104 may perform some or all the virtual experience engine functions (e.g., generate physics commands, rendering commands, etc.), or offload some or all the virtual experience engine functions to virtual experience engine 104 of client device 110 (not illustrated). In some implementations, each virtual experience 105 may have a different ratio between the virtual experience engine functions that are performed on the online virtual experience server 102 and the virtual experience engine functions that are performed on the client device 110.

In some implementations, virtual experience instructions may refer to instructions that enable a client device 110 to render gameplay, graphics, and other features of a virtual experience. The instructions may include one or more of user input (e.g., physical object positioning), character position and velocity information, or commands (e.g., physics commands, rendering commands, collision commands, etc.).

In some implementations, the client device(s) 110 may each include computing devices such as personal computers (PCs), mobile devices (e.g., laptops, mobile phones, smart phones, tablet computers, or netbook computers), network-connected televisions, gaming consoles, etc. In some implementations, a client device 110 may be referred to as a user device. In some implementations, one or more client devices 110 may connect to the online virtual experience server 102 at any given moment. It may be noted that the number of client devices 110 is provided as illustration, rather than limitation. In some implementations, any number of client devices 110 may be used.

In some implementations, each client device 110 may include an instance of the virtual experience application 112. The virtual experience application 112 may be rendered for interaction at the client device 110. During user interaction within a virtual experience and in association with the media presentation component 130, an avatar of a user may view an interactive digital media presentation, including, e.g., video content of the media with audio. Using data related to context, prior user interactions, and prior user engagement with various virtual experiences, the interactive digital media presentation may present one or more virtual items that may be of interest to the user, may present media related to an experience or third-party content, and others.

The placement, viewpoint, perspective, and time spent viewing of the avatar associated with the user may all be used to track media impressions as described herein with the media presentation component 130 and/or other components of platform 100.

In some implementations, the media presentation component 130 may provide control and provisioning of digital media presentations within virtual experiences served by the online virtual experience platform 100. For example, digital media may be viewed by an avatar, and automatically altered, paused, resumed, etc., depending upon interaction of the avatar with the digital media.

The media presentation component 130 may receive indications that particular avatars are within proximity of digital media display elements and may initiate presentation of media based on characteristics associated with the respective users. The media presented may vary across users, even when viewing the same digital media display element within the same virtual experience. For example, two avatars positioned near the same digital media display element may be presented with different media depending on attributes associated with each user. Media selection may be based on permitted user data such as demographic attributes (e.g., age, location, language), prior activity within the virtual experience (e.g., previously viewed content, avatar appearance, previously engaged display elements), and optionally, engagement patterns or associations with other users on the platform. The selected media may correspond to a matched target demographic or other presentation logic criteria.

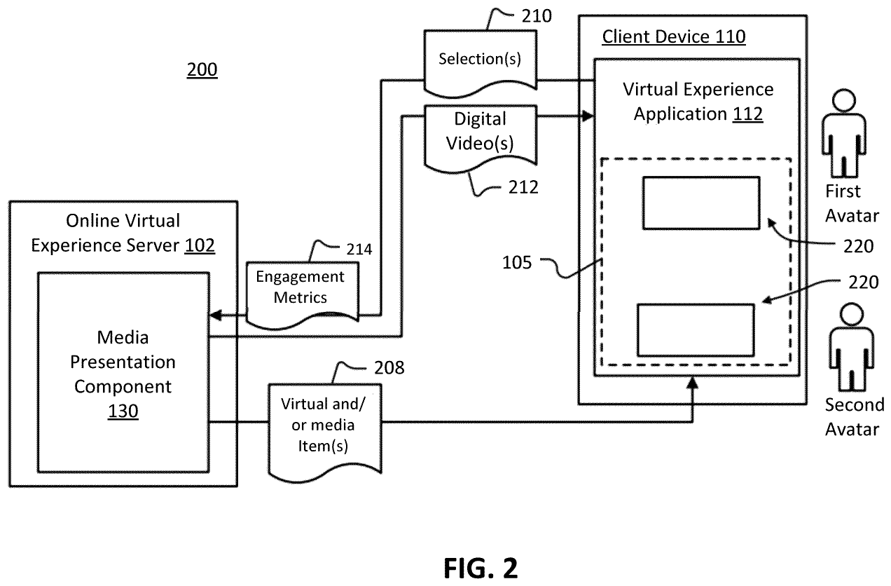

Hereinafter, an example flow of presenting digital media using digital media display elements such as billboard, walls, surfaces, items, objects, and others, is described with reference to FIG. 2.

### Digital Media Architecture

FIG. 2 is a diagram of an example system architecture 200 to present digital media within a virtual experience, in accordance with some implementations. The system 200 includes an online virtual experience server (hereinafter server) 102, a client device 110, and a media presentation component 130, which may be implemented as a logical or functional component within the server 102. A virtual experience application 112 executes on the client device 110 and renders the virtual experience 105 for one or more users (e.g., a first user and a second user). The system architecture enables media selection, presentation, user interaction, and engagement metric generation associated with digital video(s) 212 and other supported media types.

The online virtual experience server 102 coordinates the delivery of virtual environments and media content to participating users. The media presentation component 130, hosted at or integrated with the server 102, receives media assets such as digital video(s) 212 and associated configuration data from media providers or developers. In various implementations, this configuration data may include presentation parameters such as, e.g., target demographic attributes, display eligibility rules, viewing thresholds, reward eligibility conditions, and selection logic used to tailor the media presentation to specific users or contexts.

The client device 110 may be used by the first user and the second user to access and interact with the virtual experience 105 via the virtual experience application 112. Within the rendered environment, one or more digital media display elements 220 may be positioned at locations defined by a developer or experience author. These elements serve as surfaces or regions where media content, including the digital video(s) 212, may be presented to avatars under specific conditions.

As users navigate the virtual experience 105, the system may detect that an avatar associated with a user is within a threshold distance from a digital media display element 220. In various implementations, spatial telemetry data may include, e.g., position, orientation, motion, and view vector of the avatar, enabling determination of whether viewability criteria are satisfied. The media presentation component 130 uses this data to determine if the perspective of the avatar is aligned with the display element 220 and if the media is sufficiently visible.

In addition to viewability conditions, the media presentation component 130 may determine, based on one or more level of interest criteria, that a level of interest of the user meets a threshold level. In various implementations, the level of interest criteria may include one or more of: a dwell time near the digital media display element 220, sustained avatar or camera orientation toward the element, a raycast-based unobstructed line of sight to the display surface, or alignment with a central region of the viewport. In some implementations, the component 130 may combine multiple such inputs to compute a cumulative level of interest score.

If both the viewability criteria is determined to be satisfied and the level of interest is determined to meet a threshold level, the media presentation component 130 initiates presentation of the digital video(s) 212 at the corresponding digital media display element 220. The video content of the media may be accompanied by mixed spatial audio that combines the media audio with audio from the virtual experience. In some implementations, the media audio and audio from the virtual experience are dynamically adjusted according to the position of the avatar and the playback mode. In some implementations, playback may begin with the video muted and only unmuted upon user interaction.

In some implementations, prior to initiating playback, the system may render a non-playing visual frame or static image representing the media content. This enables the behavior of the avatar in response to the still frame to further inform or refine the level of interest determination. For example, if an avatar lingers while oriented toward the static image, the likelihood of meaningful engagement may increase.

In some implementations, the virtual experience application 112 provides interactive controls to the user. In some implementations, the interactive controls include a full-screen activation control. Upon user activation, the application may interpolate the virtual camera toward the digital media display element 220 to enhance visibility while preserving peripheral context. In some implementations, the interaction of the user with these controls and proximity to the display surface are tracked for engagement analysis.

In various implementations, the media presentation component 130 collects engagement data such as, e.g., user interactions, total duration of playback, duration of continual playback time, completion status of the digital video(s) 212, transitions between playback modes (e.g., entering and exiting full-screen), and avatar presence metrics. This data is compiled as engagement metrics 214 and transmitted back to the server 102.

In some implementations, the engagement metrics 214 can be used to determine whether the user is eligible to receive a virtual reward, such as a cosmetic item or experience currency, based on rules defined by the media provider or developer. For example, a user who completes playback while maintaining a minimum threshold level of engagement, based on the engagement metric generated for the media, may be rewarded accordingly.

In some implementations, the media presentation component 130 may consider access control rules when selecting media for presentation. These rules may include constraints based on user attributes (e.g., age, region, or subscription tier), virtual experience metadata (e.g., genre or theme), developer-defined limits, or media provider policies.

In some implementations, developers may place multiple digital media display elements 220 within the virtual experience 105. In some implementations, platform-level policies or campaign configuration may impose limits on the number or density of display elements per experience to prevent oversaturation and preserve immersive quality.

In some implementations, The system may support media-linked interaction flows, such as selecting virtual or physical items depicted in the media for preview, trial, or purchase. For example, if a digital video 212 depicts a virtual item 208, a user may interact with the media to preview how the item appears on the avatar. Selection(s) 210 may be sent from the client device 110 to initiate a try-on or transaction. Upon purchase, the item may be added to the inventory of the user.

For example, a footwear brand may submit a digital video 212 depicting a real-world shoe offering (such as, e.g., a video depicting advertising content for the shoe offering). The video may highlight features such as materials, design, performance, or use in real-world contexts, and may be targeted for presentation to users who match specific demographic or engagement profiles. When the video is presented at a digital media display element 220 within the virtual experience 105, the user may engage with the media via interactive controls made available through the virtual experience application 112. In response to either initiating interaction with the media or engaging with the media through completion of playback, the system may provide the user with a virtual representation of the real-world shoe offering, which may be added to the inventory of the user for avatar use.

The conditions for granting the virtual item may be defined by the media provider within the media configuration submitted to the media presentation component 130. For example, the virtual shoe may be granted upon the user viewing at least a threshold portion of the video, completing the entire video, or selecting a designated interaction element embedded within the media. Upon detecting that such conditions are satisfied, the media presentation component 130 may issue a command to update the inventory associated with the user account on the virtual experience platform.

The media may, for example, contain a link or embedded trigger for initiating a transaction involving the real-world shoe product. The user may be redirected to a commerce interface, external storefront, or embedded shopping portal. These user selections 210 may be tracked alongside engagement metrics 214 to provide data to the media provider on the effectiveness of the media, including downstream actions taken by users such as item acquisition, redirection, or time spent viewing product-linked content.

In some implementations, the platform may assign a monetization value to a completed media view, item interaction, or conversion event. In some cases, a developer may receive virtual currency or other compensation when media presented in their experience results in high engagement or item transactions.

In some implementations, media providers may participate in a bidding framework in which the media presentation component 130 selects media based on submitted bid specifications. Bids may be placed for conditions such as: presentation to a user determined to exceed a threshold level of interest, confirmed engagement based on the engagement metrics 214, or a completed viewing duration (e.g., 2-second view, 15-second view).

In some implementations, unique users and unique impressions may be identified for purposes of bid validation or reporting. A unique user may be defined as a user who engages with the media for the first time during a session or campaign, and a unique impression may be tied to a new presentation event satisfying minimum visibility and duration criteria.

In some implementations, engagement metrics 214 may track interactions across multiple digital media display elements 220. For example, billboards, signs, or virtual monitors in different parts of a virtual experience may each produce separate engagement signals. In various implementations, these metrics may be used for, e.g., campaign evaluation, payout determination, or experience optimization.

In some implementations, metrics may include aggregate values such as, for example, total number of viewers, total playback time, impressions per time window (e.g., per week), or per-group breakdowns (e.g., per demographic group). In some implementations, additional engagement metrics 214 may include, for example, per-group average watch time, conversion rates, and average revenue per user.

In some implementations, the media presentation component 130 may analyze spatial telemetry to compute precise viewability and engagement values. This may include, for example, angle-of-view calculations, distance-based attenuation, or pixel-based surface coverage estimations.

In some implementations, partial or full impressions may be determined based on a visibility score computed from one or more parameters including, e.g., a duration that the media remained within the viewport of the user's avatar, a percentage of the media display surface visible within the viewport, and an occlusion state of the media during the duration. For example, clarity of visibility of the media may be determined based on whether the avatar of the user has an unobstructed, direct (e.g., perpendicular) view of the digital media element (in which case clarity is 100%) or whether the view is obstructed (e.g., the digital media element is partially blocked by another object), is too far from the avatar (in which case small details may not be noticed), or viewed from an angle (e.g., if the avatar is very close to or to the side of the digital media element), in which case clarity is less than 100%. In various implementations, time-based or spatial thresholds may govern what qualifies as a valid impression.

In some implementations, personalized presentation may be provided at the digital media display element 220, such that different avatars in proximity may be shown different media items. For example, a first avatar may be shown one digital video 212 while the second avatar receives a different one, even though both are viewing the same display element.

In some implementations, media playback may be independently controlled for each user. If an avatar of a user turns away or exits a threshold proximity of the digital media display element 220, playback may pause or terminate for the user, while continuing for others.

Hereinafter, several definitions and terms associated with presenting digital media in a virtual experience are provided for clarity of discussion.

### Definitions

A data model is a hierarchical structure of digital assets that define the spatial, interactive, and behavioral composition of a virtual experience. The data model may include, e.g., environment geometry, user avatars, interface elements, and logic scripts governing user interaction and experience state.

A model is a container asset that is composed of one or more components, such as parts, scripts, meshes, or visual effects. Models may represent objects within the virtual environment, including user-facing elements such as screens or interactive surfaces.

An instance is a runtime instantiation of an asset within the virtual experience. Instances may represent users, objects, models, or components that are loaded and rendered dynamically based on platform execution state.

A media presentation graphical user interface (GUI) is a GUI instance used to present interactive controls for managing the playback or user interaction with digital media. This may include, for example, buttons for full-screen activation, volume adjustment, skipping, or interacting with associated virtual items.

A digital media display element is a defined surface, region, or in-world object capable of rendering media content to one or more avatars within a virtual experience. Examples may include virtual billboards, portals, signage, monitors, or other in-world surfaces where media can be positioned and viewed. Each display element may support personalized playback per user and is subject to presentation based on viewability and determined level of interest.

Media is content submitted by a media provider or developer for presentation within a virtual experience. Media may include, e.g., video, still images, holographic content, special effects, interactive elements, or animated sequences. Media is delivered by the media presentation component, and may include configuration settings that govern, e.g., presentation behavior, target demographics, reward triggers, and bid conditions.

Various formats of interactive media presentations may be supported within the online virtual experience platform. These formats enable the dynamic rendering and engagement of media content, such as video, interactive panels, or branded visual surfaces, within a three-dimensional environment rendered to users via the virtual experience application 112. Although the following formats may include advertising-based use cases, the media presentation component 130 may support entertainment, educational, or promotional media of other kinds.

### Interactive Media Formats

The online virtual experience platform may support static or semi-static visual media elements, such as billboards, surface overlays, or framed graphical content rendered on a digital media display element 220. These elements may be configured to be interactive, clickable, or reactive to proximity-based triggers. Developers may place such display elements via graphical user interface (GUI) tools and may choose to apply static visual media directly onto compatible surfaces (e.g., building facades, interior walls) to replicate signage, mural-style content, or branded visual installations.

Examples of supported media formats may include, but are not limited to:

Visual display elements that include animation triggers, such as lighting effects, motion, or audio cues, when a user avatar moves within a defined proximity radius.

Clickable or interactive image-based media items that, upon user selection, display linked assets, generate scannable QR codes, or prompt actions within or outside the virtual environment.

Dynamic media containers that modify their appearance or behavior in response to avatar interaction (e.g., changing color when stepped on, altering border effects when hovered over, or initiating sound playback).

In-world elements that incorporate interactive media into gameplay objectives, such as gates, checkpoints, or challenges that require viewing or responding to the media to progress or unlock rewards.

Video-based media units that support looped playback, animated sequences, motion graphics, or audio-enhanced content. Playback may include spatial audio rendered in the virtual experience based on the position of the digital media display element and avatar location. Users may be drawn to the source of audio and visually engage with the associated media item, which may become interactive once proximity, viewability, or interest criteria are satisfied.

Digital media display elements 220 may become interactive based on various forms of detected user engagement, including:

Avatar movement within a threshold radius of the display element.

Alignment of the viewport of the user or camera orientation toward the media element.

User selection, click, or activation of a user interface (UI) control associated with the media.

Real-world attributes such as user location, when enabled by appropriate permission settings and platform security controls.

These engagement events may trigger one or more interactive behaviors, including:

Enabling a purchase interface for virtual items linked to the media. This may include teleportation to a branded virtual storefront, a try-on sequence for avatar customization, or in-environment purchasing of the depicted virtual item.

Linking to purchase workflows for real-world items. For example, a media item showing a real-world shoe offering may direct the user to an external or embedded commerce interface, or issue a scannable code for in-person purchase redemption.

Prompting calendar-related actions, such as adding an event shown in the media (e.g., a concert or product launch) to a virtual platform calendar or external calendar of the user via API integration, with user consent.

Issuing digital rewards such as promotional codes or scannable QR codes to a virtual wallet or secure storage associated with the user account. Such codes may be transmitted via out-of-band communication (e.g., email or in-app messages).

In some implementations, media may be graphically embedded or wrapped onto virtual items. For instance, a branded skin may be applied to a wearable, vehicle, or accessory item shown in the virtual experience. These re-skinned items may include, for example, a logo of a media provider, artwork, or thematic texture related to a campaign, product line, or cultural reference.

In some implementations, media-triggered user actions may result in platform-tracked rewards tied to engagement metrics 214. For example, a user who completes viewing of a digital video 212 associated with a media campaign may receive a virtual item, platform currency, or entry into a promotion. Rewards may be tiered based on, e.g., total duration of playback, duration of continual playback, a completion status of the video content of the media, one or more transitions between presentation modes, number of viewings, user interactions, or a combination of these.

In some implementations, rewards may include first-tier virtual currency usable across the platform, or second-tier currency dedicated to engagement-driven campaigns. These currencies may be tracked separately, with the latter redeemable in a reward-specific storefront or experience. Additional virtual currencies or reward types may be defined as needed by the platform.

In some implementations, physical items may be offered as part of media-linked campaigns. These may include, for example, clothing, merchandise, collectibles, or event tickets, and may be distributed through secure redemption mechanisms. Alternatively, users may receive virtual item equivalents of real-world products for avatar use or social sharing. Other rewards and incentives may be configured by the platform or media provider depending on the implementation context.

### Interactive Media Moderation

In some implementations, users may report media content presented within a virtual experience if it is perceived to be misleading, offensive, or otherwise in violation of platform content policies. A reporting interface may be rendered in association with each digital media display element 220, enabling users to flag media items—such as digital videos 212 or interactive graphical elements—directly from the virtual experience application 112. Upon user submission, a report may include metadata identifying the media item, the digital media display element involved, the associated experience ID, and contextual factors such as time, location, and user identity.

In some implementations, reported media items may be routed to a media-specific moderation queue, where content is reviewed by automated techniques, platform moderators, or both. The media presentation component 130 may tag submitted media items with relevant classification data to enable content screening and prioritization. For example, media associated with sensitive demographics, widespread distribution, or flagged by multiple users within a short time interval may be escalated for priority review.

In some implementations, a moderation framework may implement target turnaround times for review and action, such as reviewing newly submitted media within one or two hours of receipt. The framework may be configured to isolate moderation of media-related content from other categories of user-generated content, ensuring that submitted media for presentation-such as advertisements, branded videos, or campaign-linked assets-are reviewed in a dedicated pipeline with appropriate policy constraints and audit logging.

### Viewable Media Impressions

In various implementations, media impressions may be calculated on the server side or on the client side. There are at least two types of impressions: rendered impressions and viewable impressions. A rendered impression is generated whenever a media item is rendered on the client device, regardless of whether the user has an opportunity to see it. A viewable impression is generated when a media item is rendered and the user has an opportunity to see it within the virtual experience.

In various implementations, a valid impression may be based on various conditions. For example, accumulated viewing time may need to be at least 10 seconds, with only viewing intervals of at least 1.5 seconds contributing to that total. The media item may need to occupy at least 1.5% of the screen area. The viewing angle between the media surface and the screen plane of the user may need to be no more than 55 degrees. Additionally, at least 50% of the media is visible on screen. Other variations may be applied. Metadata such as the user ID, timestamp, display element identifier, and contextual attributes may be recorded. Lighting conditions, avatar movement, motion of the media item, and other dynamic factors may further influence whether an impression is considered valid.

In some implementations, raycasting may be used to determine full or partial impressions. Rays may be cast from an avatar or camera position toward the media surface, or from the digital media display element toward the avatar.

In some implementations, random raycasting may be used to calculate obstruction percentages. Random rays may be cast from an avatar or user viewport toward the media element at regular intervals. The percentage of rays that are not obstructed may be accumulated over time to estimate visibility.

In some implementations, at least five rays may be cast to determine whether a media surface is obstructed or visible. The raycasting may be repeated periodically during media playback to account for changing avatar position or environmental conditions.

In some implementations, non-human activity may be considered when calculating impressions. Factors such as, e.g., idle time, inactivity within the experience, or lack of interaction may be used to disqualify impressions that do not reflect genuine user engagement.

In various implementations, various forms of viewable media data, including screenshots, viewport renderings, and user perspective information may be captured to audit media impressions and associated engagement. For example, user viewport snapshots may be saved to verify whether a media item was onscreen and unobstructed during playback.

In some implementations, masking techniques may be applied to determine whether media is visible. For example, a mask of non-media areas may be applied to a viewport of a user to calculate what percentage of the screen was occupied by media. Similar masking may be used to determine whether the view of the user was overloaded with media items or if media was improperly obstructed.

In various implementations, additional impression validation rules may incorporate international or local standards. For example, some implementations may apply specifications from the Interactive Advertising Bureau (IAB) or similar industry groups to guide impression validation. Under IAB guidance for in-experience display media, size and visibility thresholds may include: at least 1.5% of the screen occupied, no more than 55 degrees angle between the media plane and the viewer, and at least 50% of the media visible on screen. These numbers may vary depending on implementation. IAB time requirements may define a valid impression as requiring at least one continual second of media visibility post-render. The time requirement may differ depending on whether the media is static (e.g., image), animated (e.g., looped video), or interactive. Multiple thresholds may be applied, such as 2-second and 15-second view durations, either as individual or cumulative values. For example, a user moving quickly past a display element may briefly break visibility but still satisfy the overall condition. For sampling-based validation, IAB standards recommend a polling frequency of 200 ms. Lower sampling frequencies may be permitted if validated to yield comparable results. Other factors that impact visibility-such as contrast, shading, lighting, or overlapping visual effects-are not explicitly defined by current standards. These may be accounted for using custom scoring or platform-specific heuristics.

In some implementations, sampling methods may be used to evaluate per-frame compliance with viewability conditions. State-change tracking may be employed, though it may be more computationally demanding in highly dynamic environments.

In various implementations, sampling techniques may include raycasting, bounding box overlap checks, or screen-space pixel analysis to determine whether a media item satisfies viewability thresholds. These methods may be used independently or in combination to evaluate valid impressions for media presented within the virtual experience.

### Creating Interactive Media Presentations

Developers of virtual experiences may configure interactive media presentation sets and campaigns for integration into a virtual experience. In some implementations, the platform may provide a set of media insertion tools accessible via the media presentation component. These tools may enable developers to browse a gallery of predefined digital media display elements or templates (e.g., interactive video panels, spatial audio billboards, branded virtual objects), select a desired element from a visual interface, and place it directly into a virtual experience environment.

In various implementations, placement may include dragging and dropping a digital media display element to any location within the experience, with support for, e.g., resizing, maintaining aspect ratios, enforcing minimum size constraints, or snapping to environmental geometry. Developers may preview, reposition, or rotate the element in the virtual space and apply optional configuration settings such as, e.g., playback triggers, spatial audio behavior, and engagement thresholds. In various implementations, the developer may associate specific media items (e.g., video content of the media, branded effects, virtual product showcases) with a selected display element and define rules for, e.g., viewability criteria, target demographics, determined level of interest, and reward conditions.

### Defining a Media Presentation Set

In some implementations, a media presentation set may be used by a media provider to define a target audience for a given set of media items. Targeting attributes may include user characteristics such as, for example, country, age range, gender, account type, or other demographic data available to the virtual experience platform. Selection of these attributes may dynamically adjust the media presentation preferences or eligibility constraints for a particular media item.

In some implementations, a media provider may define multiple media items or variants, each tailored to a specific target demographic or subset of users. For example, a first media item may be configured for users aged 18-21 in North America, while a second version may be designated for users aged 18-24 in Europe, with distinct presentation logic or visual treatments.

In some implementations, media presentation preferences may incorporate device-based criteria. These may include hardware capabilities such as, e.g., processor speed, memory capacity, battery level, graphics support, or manufacturer and model.

### Minimum Distance Between Media Display Elements

In some implementations, to maintain a balanced user experience and avoid displaying too many digital media items, a minimum spatial separation may be enforced between digital media display elements within a virtual experience. For example, a default configuration may require that two or more display elements be placed at least a threshold distance (e.g., 100 meters) apart within the virtual environment.

In various implementations, the threshold distance may be configurable based on, for example, experience type of the virtual experience, user demographics (accessed with user permission), developer restrictions specified by a developer of the virtual experience, one or more media provider policies of a media provider associated with the media, platform-wide policies, or any combination thereof. These rules may be applied at design time by the media presentation component, or enforced dynamically during experience compilation or publishing workflows.

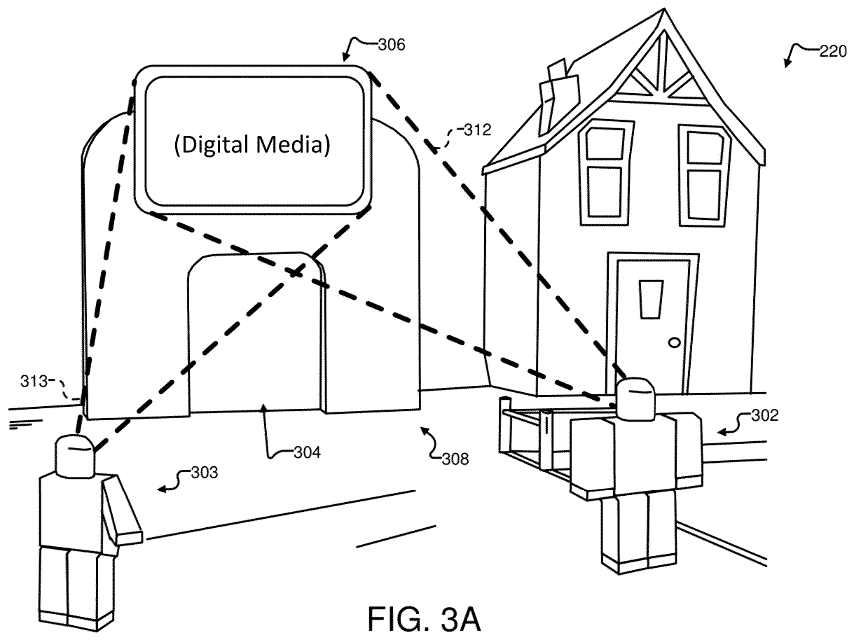

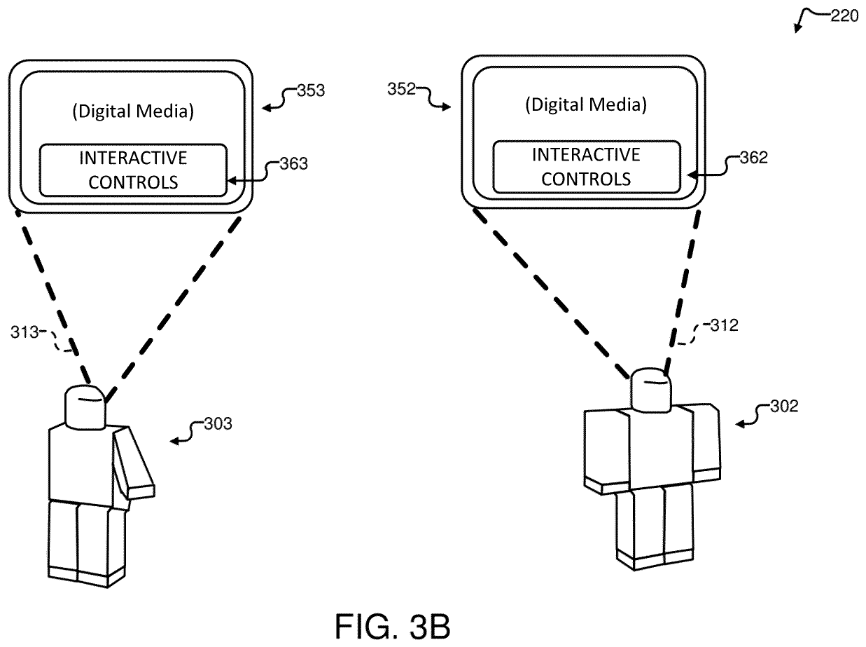

Hereinafter, example visualizations and configurations of the digital media display element 220 are described in detail below with reference to FIG. 3.

### Digital Media Display Element

FIG. 3A is a perspective view of a digital media display element, and FIG. 3B is a diagram illustrating multiple avatars viewing respective digital media display elements, in accordance with some implementations. It is noted that the description provided in reference to FIG. 3A and FIG. 3B are illustrative only, and not limiting. For example, actual appearance of a digital media display element may be varied in many ways. Furthermore, the number, types, and displayed media may be altered in many ways. Moreover, the simplified schematic shown is for illustrative purposes only, and does not include all variations which may be applicable to example embodiments.

As shown in FIG. 3A, a display 306 may be configured to present digital media associated with one or more media items. In some implementations, the display 306 may be a standalone visual component that can be positioned in various locations within a virtual experience, such as on a billboard, wall, or other in-world surface. In some implementations, the display element may include or be positioned near a portal element 304. The portal element 304 may optionally enable the avatar to transition to another virtual experience or a media-specific sub-experience. Additional structural elements 308, such as lintels or doorway surrounds, may be included for aesthetic or contextual integration. The displayed media may be static (e.g., an image or banner) or dynamic (e.g., a looping or interactive video).

In various implementations, the display 306 may be used independently, without any associated portal clement, or it may be displayed as part of a virtual item, structure, or floating object within the experience. Digital media display elements may be placed on flat or curved surfaces, attached to virtual objects, embedded within architectural elements (e.g., doors, roofs, or walls), applied to avatar clothing, or integrated into environmental elements.

In some implementations, the display 306 may optionally display a fallback or default media item when no user-targeted or dynamically selected media is available. A fallback display may consist of static or looped content (e.g., images, ambient videos, audio clips) chosen to be broadly applicable across experiences and suitable for all users. Example fallback media may include branding assets (e.g., a platform provider logo), default avatar animations, or non-targeted media without sensitive content.

In various implementations, fallback or default media may be selected according to developer preferences, platform-wide settings, or user-specific settings (e.g., an account option to suppress personalized media). These default displays may include interactive elements such as, for example, zoom controls, audio toggles, or mini-activity triggers. In some implementations, a default display may offer the same or similar interactivity as personalized media content.

In example embodiments, a display 306 may be placed anywhere within a virtual experience by a developer or designer. The quantity and positioning of such elements may be selected based on developer controls, platform-level policies, media provider specifications, or system constraints. A media campaign director or platform operator may define global or campaign-specific rules for element distribution.

In some implementations, developers may place one or more digital media display elements within an experience. The number of allowable placements may be limited by system-wide caps or throttling rules, particularly in use cases involving monetized media, to prevent excessive density of interactive displays. In some implementations, a media provider or the platform operator may enforce visual consistency requirements across digital media display elements. These may include constraints on, e.g., scale, placement, shape, or styling to ensure that media elements harmonize with the visual design of the virtual experience, follow thematic guidelines, or align with global brand policies.

As illustrated, when an avatar 302 of a user approaches a display 306, it may present selected media content. The portal element 304 may emit visual or audio cues (e.g., glow effects, spatial sound) to signify that the element is active or engaged. As the avatar 302 interacts with the digital media, user input and proximity telemetry may be recorded and applied toward the engagement metrics associated with the media item. The viewing direction of the avatar may be represented by raycast 312, which depicts a line of sight to the media.

A second avatar 303 may view the display 306, as indicated by a separate raycast 313. In some implementations, the first avatar 302 and the second avatar 303 may each be presented with different media content on the same display 306. Content selection may be based on user-specific criteria such as target demographics, user preferences, or engagement history. In some implementations, the same media may be presented to multiple users depending on overlapping eligibility conditions.

Turning to FIG. 3B, separate digital media items 353 and 352 are presented to avatars 303 and 302, respectively. Each digital media item may include corresponding interactive controls 363 and 362 rendered as part of a digital media display element 220. The interactive controls may include play, pause, skip, volume adjustment, full-screen toggle, or other media-related controls. Depending on a given interaction of the avatar with the interactive controls, the playback state, audio configuration, or visual rendering of the media may be modified to accommodate the preferences of the user while maintaining continuity within the virtual experience.

For example, avatar 303 may be presented with a first digital media item 353. If the avatar interacts with interactive controls 363 to activate full-screen viewing, the platform may responsively render an expanded version of the media item 353 while preserving elements of the virtual experience environment. This may include retaining ambient audio from the surrounding virtual experience, preserving partial peripheral visibility of nearby objects or avatars, and enhancing the playback audio of the media item itself. The line of sight 313 of the avatar may remain focused on the enlarged digital media, while the visual and auditory context of the environment is maintained. The same or similar interaction flow may occur for avatar 302 in connection with digital media item 352 and interactive controls 362.

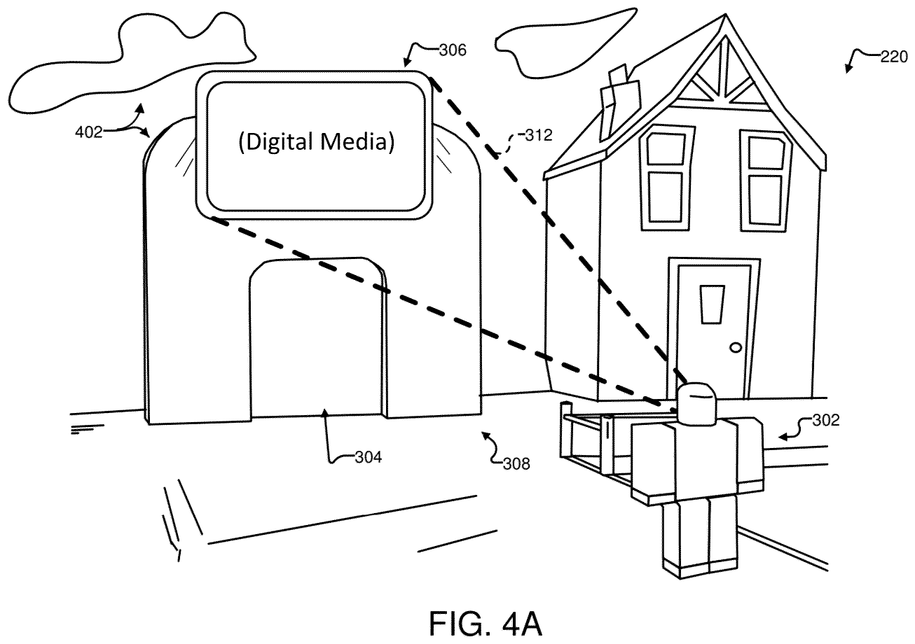

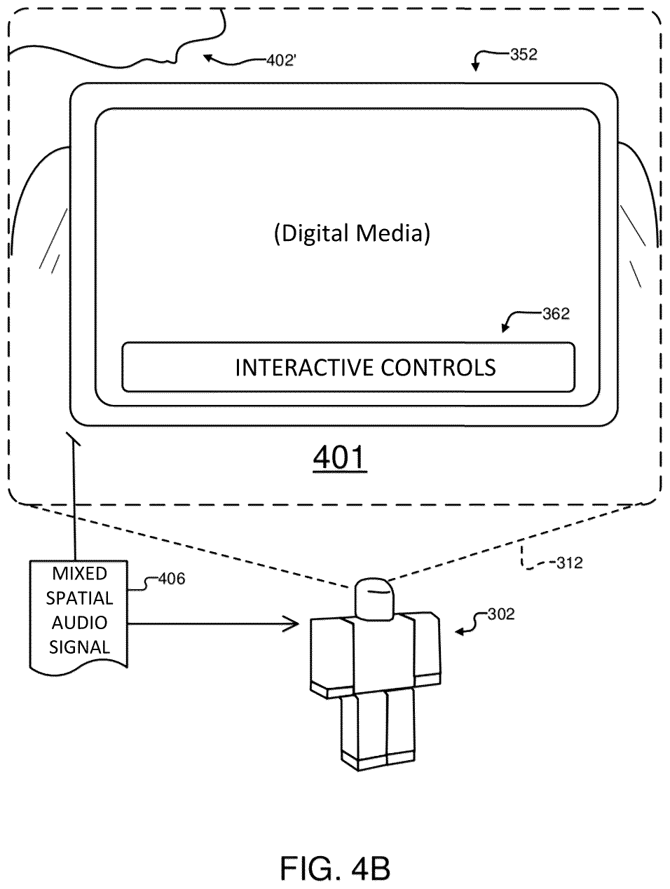

Hereinafter a more in-depth description of digital media playback and viewing is provided with reference to FIGS. 4A-4B.

### Digital Media Playback

FIG. 4A is a perspective view of a digital media display element, and FIG. 4B is a diagram illustrating an avatar viewing digital media, in accordance with some implementations. It is noted that the description provided in reference to FIG. 4A and FIG. 4B are illustrative only, and not limiting. For example, actual appearance of a digital media display element may be varied in many ways. Furthermore, the number, types, and displayed media may be altered in many ways. Moreover, the simplified schematic shown is for illustrative purposes only, and does not include all variations which may be applicable to example embodiments.

In the depicted example, a display 306 is configured to present media within a virtual environment. The display 306 may be integrated with or positioned above a portal structure 304 and rendered within a virtual environment scene 402.

Upon detecting the avatar 302 is within proximity to the media display element, viewability criteria may be evaluated based on the perspective of the avatar, such as screen alignment or an unobstructed line of sight. A level of interest of the user associated with avatar 302 may be determined to meet a threshold level based on one or more level of interest criteria, such as, e.g., sustained orientation toward the display, dwell time, or interaction history. If both the viewability criteria are determined to be satisfied and the level of interest criteria is determined to meet a threshold level, presentation of media at the display 306 may be initiated.

Initiating presentation may include beginning playback of digital video and corresponding spatial audio while preserving the surrounding environmental context. In some implementations, a static image may initially be displayed on the display 306 until the criteria are satisfied. The current field of view of the avatar is represented by raycast 312 directed toward the display. If the avatar later turns away, meets a proximity threshold, or fails to continue engaging, playback may pause. User interaction with the media, including through provided interactive controls, may be tracked to generate engagement metrics. If the engagement metrics show a readiness for enhanced engagement—such as transitioning to a full-screen view—the presentation may adjust accordingly, as further illustrated in FIG. 4B.

FIG. 4B is a diagram illustrating presentation of media to an avatar in a full-screen configuration, in accordance with some implementations. As shown, avatar 302 is presented with media 352 rendered in an expanded view 401 after satisfying viewability criteria and being determined to have sufficient level of interest. The full-screen rendering may result from the avatar activating a full-screen control included in the interactive controls 362 of the digital media display clement. In this configuration, the view 401 of the avatar includes a magnified display of the media 352 while preserving partial visibility of the surrounding virtual environment 402′ and delivering audio output as a mixed spatial audio signal 406.

In some implementations, the mixed spatial audio signal 406 includes both audio content of the media and audio from the virtual experience. The mixed spatial audio signal may be dynamically adjusted based on presentation mode and user interaction with the interactive controls 362. For example, background audio volume may be decreased and media audio volume increased during full-screen playback. When the avatar exits full-screen mode or disengages, the mix may be recalibrated to emphasize environmental audio over media audio.

In some implementations, the mixing logic may adapt based on avatar proximity to the digital media display element, avatar perspective 312 (e.g., line of sight), or user-specified audio preferences. Interactive controls 362 may include volume adjustment, mute, or spatial mix toggles, enabling the user to further refine the presentation experience.

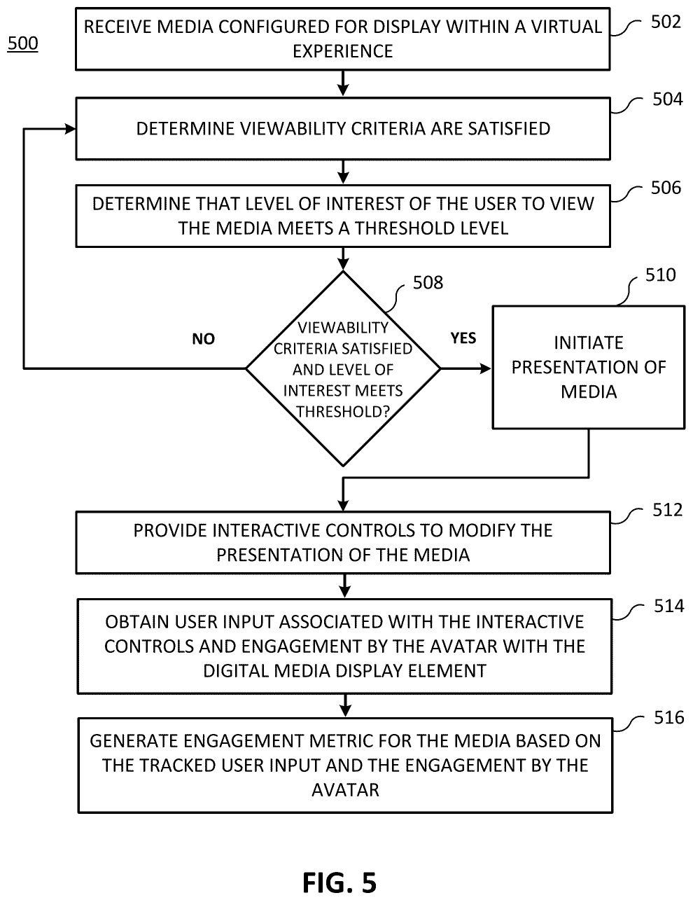

Hereinafter, methods of presenting digital media within a virtual experience are described more fully with reference to FIG. 5.

### Method of Presenting Digital Media Within a Virtual Experience

FIG. 5 is a flowchart of an example method to present digital media within a virtual experience, in accordance with some implementations.

In some implementations, method 500 can be implemented, for example, on a server 102 described with reference to FIG. 1 and FIG. 2. In some implementations, some or all of the method 500 can be implemented on one or more client devices 110 as shown in FIG. 1, on one or more developer devices (not illustrated), or on one or more server device(s) 102, and/or on a combination of developer device(s), server device(s) and client device(s). In described examples, the implementing system includes one or more digital processors or processing circuitry (processors), and one or more storage devices (e.g., a data store 108 or other storage). In some implementations, different components of one or more servers and/or clients can perform different blocks or other parts of the method 500. In some examples, a first device is described as performing blocks of method 500. Some implementations can have one or more blocks of method 500 performed by one or more other devices (e.g., other client devices or server devices) that can send results or data to the first device.

In some implementations, the method 500, or portions of the method, can be initiated automatically by a system. In some implementations, the implementing system is a first device. For example, the method (or portions thereof) can be periodically performed, or performed based on one or more particular events or conditions, e.g., a time since last media viewing meeting a threshold, a number of transports meeting a threshold, a predetermined time period having expired since the last performance of method 500 for a particular medial item or user, and/or one or more other conditions occurring which can be specified in settings read by the method.

Method 500 may begin at block 502. At block 502, media configured for display within the virtual experience is received. Media may include any digital content suitable for presentation within a virtual environment, including but not limited to video, still images, audio, holographic content, special effects, animated visual sequences, and combinations thereof. The media may be transmitted from a media provider, a media repository, or another computing resource in communication with the online virtual experience platform. In some implementations, the media may be stored in association with metadata indicating presentation parameters, content identifiers, or display preferences.

Receiving, in this context, may include the act of acquiring media data into a system memory or storage location accessible by a media presentation component of the virtual experience platform. Receipt of the media may occur over a network connection or through a local upload mechanism. In some implementations, receiving the media includes parsing associated metadata to extract configuration information, such as media type, encoding format, resolution, playback duration, and timing constraints. The received media may be stored temporarily or persistently for subsequent presentation in one or more virtual experiences.

In some implementations, the received media is associated with a target demographic. A target demographic may include a defined subset of users based on one or more user attributes, including but not limited to age range, geographic location, language, subscription tier, previous platform activity, or user preference data. Association of media with a target demographic may be encoded in metadata accompanying the media or may be established via a campaign management interface used by a media provider. The association may be used in later processing stages to filter or select media for display based on a match between a profile of a user and the defined demographic parameters. Block 502 may be followed by block 504.

At block 504, it is determined that one or more viewability criteria are satisfied based on a perspective associated with a user relative to a digital media display element positioned within a virtual experience. The virtual experience may include a three-dimensional environment rendered on a client device, with interactive content and user-controlled avatars. A digital media display element may include any virtual object or surface capable of displaying media within the environment, such as a billboard, mounted display, embedded panel, or similar structure. A user may be represented by an avatar, which is a digital character or proxy rendered within the virtual space. The user may interact with the virtual experience through this avatar and view the environment through a virtual camera that is either associated with the avatar or independently controlled.

Viewability criteria may be based on screen-space parameters calculated from a perspective of a camera. The viewability of a digital media display clement may be assessed by projecting the boundaries of the media surface from world space into screen space, computing the size and position of the projected area within the viewport of the user, and analyzing factors such as surface visibility, alignment, and obstruction. These calculations allow for determining whether the media is visually accessible to the user through the rendered display. The position and orientation of the camera define the field of view, and media display elements may be determined viewable based on their screen occupancy and clarity within that field.

In some implementations, viewability criteria may include one or more of the following: a minimum visible area of the display within the user's viewport (e.g., a defined percentage of screen space or a minimum pixel count), a maximum angle between the forward vector of the camera and the normal vector of the display surface (e.g., 55 degrees), a duration of visibility within the viewport (e.g., 1.0 second or more), and a determination of whether the view is unobstructed using raycasting or other geometric analysis. These criteria may be used individually or in combination to determine whether a digital media display element is viewable.

The avatar may occupy various positions within the virtual environment relative to the digital media display element, such as in front of, below, to the side of, or behind the element. In addition to avatar positioning, the system may consider the configuration of the virtual camera, which defines the viewing perspective. The camera may be attached to the avatar or may be decoupled, depending on the design of the experience. Viewability may be determined based on the rendered output as seen through the camera, enabling support for different experience formats, including third-person, first-person, and non-avatar-based scenarios. Block 504 may be followed by block 506.

At block 506, a level of interest of the user to view the media is determined, based on one or more level of interest criteria, to meet a threshold level. A level of interest may include an assessment of whether the conditions associated with user attention or exposure are satisfied over a defined time window. The determination may be based on observed viewability conditions measured at discrete intervals, and evaluated to confirm whether the user had a sufficient opportunity to view the media. A determination that the level of interest meets a threshold level may be a prerequisite for initiating media presentation or logging a successful impression.

The level of interest criteria are one or more quantifiable conditions used to determine that the level of interest of the user satisfies a configured threshold. For example, level of interest criteria may include: whether the digital media display element is on screen; whether the display occupies a minimum percentage of screen space, such as at least 25 percent; whether the viewing angle between the camera vector and the plane of the media surface is within a defined angular threshold, such as 55 degrees; whether the view is unobstructed based on raycasting or visibility checks; and whether the viewing duration exceeds a minimum value, such as one second. These criteria may be sampled at defined polling intervals, such as every 200 milliseconds, and evaluated over a moving time window to determine whether the majority of samples meet the criteria.

In some implementations, the determination that the level of interest meets a threshold level may involve checking whether the user satisfied the criteria for a sufficient portion of the sampling window. For example, if a user satisfies all viewability criteria during more than 50 percent of sampling points in a defined window, the level of interest may be determined to meet the threshold. The evaluation may tolerate intermittent failures due to occlusion, changes in viewing angle, or temporary movement, and still recognize that the user had a valid opportunity to view the media. This enables the system to account for dynamic changes in the virtual environment and user behavior, while still maintaining a basis for recognizing viewability.

In some implementations, the system may distinguish between three stages: (1) the media was selected and fetched on the server; (2) the media was rendered and presented on the client; and (3) the media was determined to be viewed, based on satisfaction of the level of interest criteria. The third stage corresponds to view-level recognition and may be used for reporting impressions, triggering rewards, or updating media performance metrics. The determination at this stage is based on confirming that the user met or exceeded a predefined level of screen presence, clarity, and duration as measured through viewability checks. Block 506 may be followed by block 508.

At decision block 508, it is determined whether the viewability criteria are satisfied and the level of interest criteria meet the threshold level. If the viewability criteria are satisfied and the level of interest criteria meet the threshold level, decision block 508 is followed by block 504. If either the viewability criteria are not satisfied or the level of interest criteria do not meet the threshold level, decision block 508 is followed by block 510.

At block 510, in response to the determination that the viewability criteria are satisfied and the determination that the level of interest meets the threshold level, a presentation of the media within the virtual experience is initiated. One or more components of the media associated with a digital media display element are rendered within the digital media display element. In some implementations, this includes rendering video content of the media in the visual field of the avatar and initiating audio output that corresponds to the media.

Video content of the media may include a temporal set of visual frames associated with a digital media item, such as a video clip, animation, or other motion-based media. The video content of the media is associated with a particular digital media display clement and rendered such that it appears integrated within the virtual environment (e.g., on a billboard, display surface, or embedded object within the virtual scene). The rendering may depend on the position, orientation, and distance of the avatar relative to the digital media display element.

Concurrently, mixed spatial audio is played back. Mixed spatial audio may include an audio output that combines two or more audio sources in a spatially aware manner. The audio sources include at least (1) audio content of the media being presented (e.g., narration, music, or dialogue associated with the video), and (2) audio from the virtual environment (e.g., environmental sounds, audio of other users, or spatially relevant background effects). In various implementations, the spatial mix may be adjusted dynamically based on the location of the avatar, view orientation, or the selected media presentation mode (e.g., standard view or full-screen view). In various implementations, the spatial audio may use, e.g., volume attenuation, panning, or other signal processing techniques to maintain a coherent auditory experience aligned with the perspective of the avatar. Block 510 may be followed by block 512.

At block 512, interactive controls to modify the presentation of the media are provided to the user through the virtual experience interface. Interactive controls may include GUI elements rendered within the virtual environment or associated with the digital media display element that accept user input and modify one or more aspects of the media presentation. In various implementations, these controls may include, e.g., buttons, sliders, toggles, or other selectable objects operable by user input methods supported by the virtual experience platform, such as, e.g., mouse clicks, touch inputs, gamepad inputs, or in-world interactions.

In some implementations, the interactive controls include at least a full-screen activation control. The full-screen activation control is a user-selectable element that, when activated, modifies the presentation of the media to occupy a larger portion of the visual field of the user. The media may be rendered at a higher resolution or expanded size relative to the surrounding virtual environment. In some implementations, activating the full-screen control triggers interpolation of the virtual camera position of the avatar toward the digital media display clement while maintaining a peripheral view of the surrounding virtual experience. In some implementations, the virtual camera viewpoint associated with the avatar is adjusted such that the media appears larger and more prominent in the center of the screen. The interpolation includes gradually transitioning the position and orientation of the camera along a defined path, rather than switching abruptly. At the same time, rendering of the surrounding virtual environment is preserved in the outer regions of the viewport, enabling the user to remain visually anchored within the virtual experience. For example, nearby structures, avatars, or environmental effects may still be visible at the edges of the screen, supporting continuity of presence even during focused media playback. In various implementations, other interactive controls may include, for example, playback toggles (e.g., pause or resume), audio controls (e.g., mute or volume adjustment), seek bars for temporal navigation within the media, or content-specific actions such as previewing associated items. Block 512 may be followed by block 514.

At block 514, user input associated with the interactive controls is obtained, and engagement by the avatar with the digital media display element is measured. User input may include one or more actions taken by the user in response to the interactive controls provided during media presentation. In various implementations, this may include, e.g., selecting a full-screen activation control, adjusting audio settings, pausing or resuming playback, seeking within the video content of the media, or other GUI-based actions captured through the virtual experience platform. Input may be registered through client device interfaces such as, e.g., keyboard, mouse, touch screen, controller, or in-world avatar actions interpreted by the platform.

Engagement by the avatar with the digital media display element may include observable or inferable behaviors indicating interaction with or attention to the media presentation. In various implementations, engagement may include, but is not limited to, proximity of the avatar to the digital media display element, sustained directional orientation of the avatar or in-game camera toward the display, periods of uninterrupted playback, use of interactive controls, and navigation behaviors related to the digital media display element. In some implementations, engagement may be detected using telemetry data such as, e.g., movement vectors, head orientation, raycast intersections, or durations of activity within defined spatial zones. In various implementations, engagement may be measured continually or at discrete sampling intervals and can be used to update internal metrics describing user interaction with the media. Block 514 may be followed by block 516.

At block 516, an engagement metric for the media is generated based on the tracked user input and the engagement by the avatar. The engagement metric may include a quantitative or categorical value that characterizes the level or quality of interaction a user has exhibited with the media. In various implementations, this metric may be used internally by the virtual experience platform to analyze media performance, inform bidding, or trigger rewards or other platform actions. In some implementations, the engagement metric is computed using a rule-based or statistical model that weights various factors including the duration of uninterrupted media playback, frequency and type of interactive control use, and patterns of avatar positioning and view direction relative to the digital media display element.

In various implementations, the engagement metric may include scalar values (e.g., a normalized score between 0 and 1), thresholds (e.g., whether engagement met a predefined minimum), or classifications (e.g., low, moderate, or high engagement). For example, if a user completes 100% of a video playback while frequently using interactive controls, and their avatar maintains proximity and view alignment throughout, a high engagement score may be assigned. If the avatar briefly pauses near the display without interacting or watching the full video, the engagement score may be lower. In some implementations, the engagement metric is stored along with associated user identifiers, timestamps, media identifiers, or demographic tags to support later aggregation or feedback.

Blocks 502-514 can be performed (or repeated) in a different order than described above and/or one or more blocks can be omitted and/or one or more additional functions may be added. For example, blocks 504-508 may be performed repeatedly as avatars engage with the digital media display element. Blocks 504-508 may operate differently depending upon the number of avatars in proximity to the digital media display element. Blocks 504 and 506 may operate to determine whether viewability criteria is satisfied and level of interest is determined to meet a threshold level separately for different avatars based upon a number of avatars interacting with the digital media received at block 502. Block 502 may be repeated for several different digital media display elements to be placed within the virtual experience. Method 500 can be performed on a server (e.g., 102) and/or a client device (e.g., 110). Furthermore, portions of the method 500 may be combined and performed in sequence or in parallel, according to specific implementations.

### Evaluation Results for Viewability Criteria

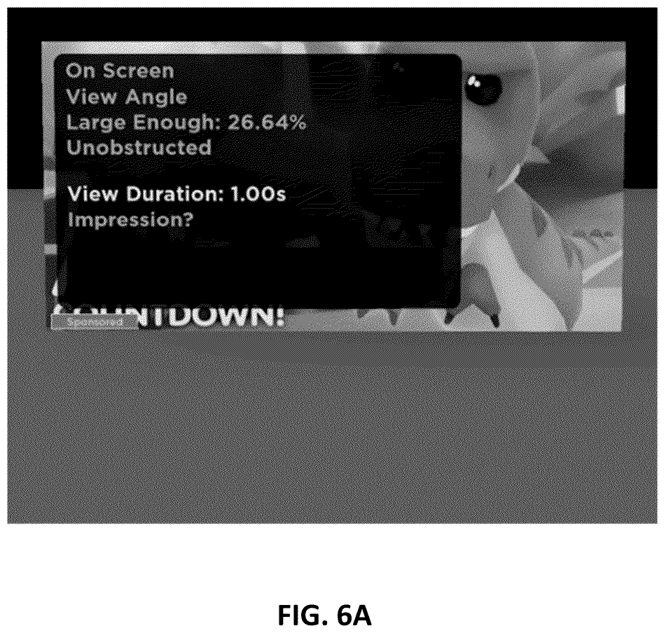

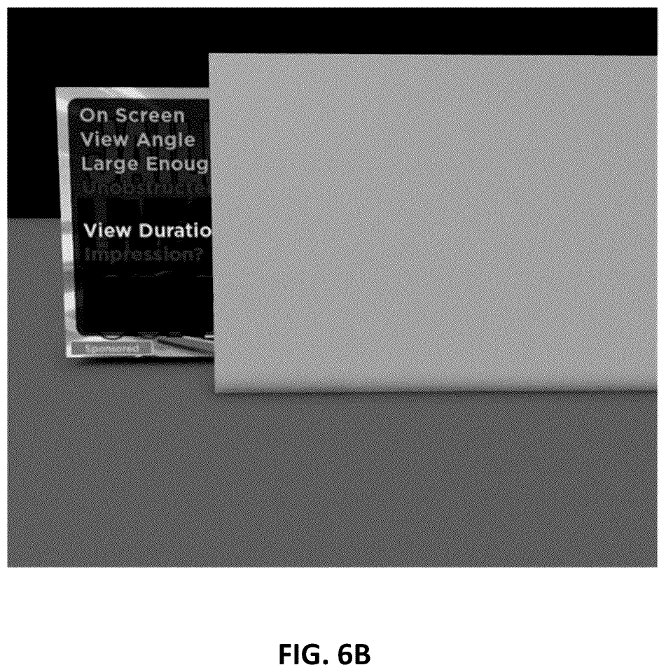

FIG. 6A is a diagram illustrating an example user interface view displaying evaluation results for viewability criteria, in accordance with some embodiments. In this example, the media comprises a digital display featuring promotional content. A viewability analysis overlay is shown, presenting real-time or sampled evaluation data used to determine whether the media display element satisfies one or more viewability conditions for a user-associated avatar.

The overlay indicates that the media is currently On Screen, meaning that the digital media display element is at least partially rendered within the viewport associated with the perspective of the avatar. The View Angle criterion is implicitly satisfied, as the view vector of the avatar intersects with the media surface at an acceptable incidence, consistent with angular thresholds such as less than or equal to 55 degrees. The Large Enough criterion is quantified with a specific percentage, here 26.64%, which reflects the proportion of the display surface area that is visible within the viewport. This exceeds commonly used minimum thresholds (e.g., 1.5% or 5%), and therefore satisfies size-based viewability.

The Unobstructed indicator shows that the media is fully visible without occlusion by other objects in the 3D scene. The View Duration is measured at 1.0 seconds, representing the accumulated or continuous time the media has met the viewability conditions. This metric may be compared against a predefined time threshold to determine impression validity, such as a minimum duration of one second. The presence of a label Impression? indicates that the system is evaluating whether all criteria have been met to register a viewable impression for the user.

FIG. 6B is a diagram illustrating an example user interface view displaying evaluation results for viewability criteria associated with a digital media display element that is partially obstructed, in accordance with some embodiments. In this implementation, a large occluding object (e.g., a virtual wall or panel) is positioned in front of the media display, blocking a substantial portion of the media from the avatar's line of sight.

The overlay indicates that the media is technically still On Screen, meaning some portion of the media display element is rendered within the avatar's viewport. The View Angle and Large Enough criteria appear to be met, suggesting that the angle between the avatar's view vector and the display surface is within acceptable bounds, and that the rendered area of the display still occupies a sufficient percentage of the viewport. However, the Unobstructed criterion is not satisfied, indicating that the media display is not fully visible due to the intervening object, which occludes a majority of the content.

The View Duration and Impression? indicators suggest that a valid impression cannot be registered under current conditions. Specifically, the system may require that all viewability criteria-including unobstructed view and minimum duration-are satisfied before counting an impression. Since the obstruction condition is not met, and the accumulated view duration is insufficient or reset due to the partial visibility, the Impression? field remains unsatisfied. This example demonstrates how dynamic scene conditions, such as occlusion by other virtual elements, may invalidate an otherwise eligible media impression despite being technically within the viewport of the user.

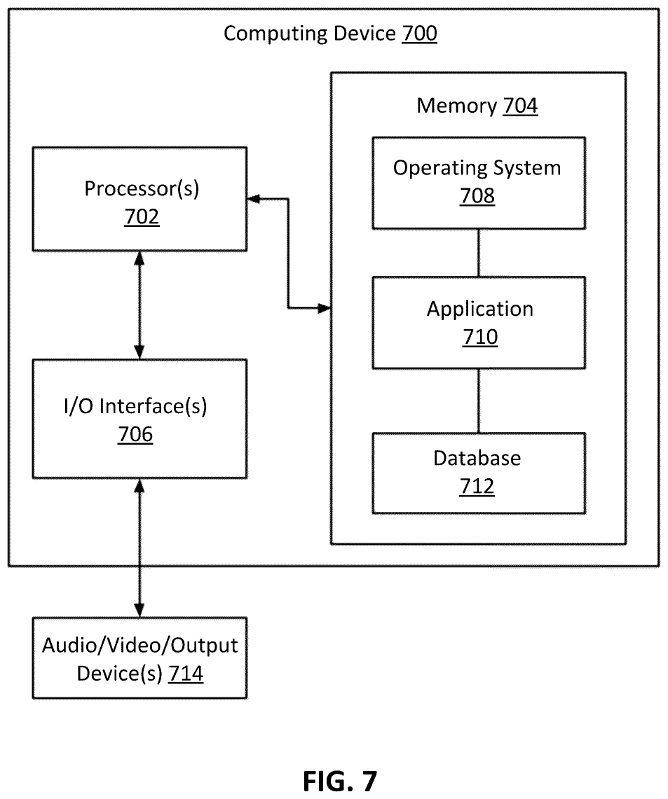

Hereinafter, a more in-depth description of various computing devices that may be used to implement different devices and/or components illustrated in FIGS. 1-2 is provided with reference to FIG. 7.

### Example Computing Device

FIG. 7 is a block diagram of an example computing device 700 which may be used to implement one or more features described herein, in accordance with some implementations. In one example, device 700 may be used to implement a computer device, (e.g., 102, 110 of FIG. 1 and FIG. 2), and perform appropriate operations as described herein. Computing device 700 can be any suitable computer system, server, or other electronic or hardware device. For example, the computing device 700 can be a mainframe computer, desktop computer, workstation, portable computer, or electronic device (portable device, mobile device, cell phone, smart phone, tablet computer, television, TV set top box, personal digital assistant (PDA), media player, game device, wearable device, etc.). In some implementations, device 700 includes a processor 702, a memory 704, input/output (I/O) interface 706, and audio/video input/output devices 714 (e.g., display screen, touchscreen, display goggles or glasses, audio speakers, headphones, microphone, etc.).

Processor 702 can be one or more processors and/or processing circuits to execute program code and control basic operations of the device 700. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 704 is typically provided in device 700 for access by the processor 702, and may be any suitable processor-readable storage medium, e.g., random access memory (RAM), read-only memory (ROM), Electrical Erasable Read-only Memory (EEPROM), Flash memory, etc., suitable for storing instructions for execution by the processor, and located separate from processor 702 and/or integrated therewith. Memory 704 can store software operating on the server device 700 by the processor 702, including an operating system 708, software application 710 and associated data 712. In some implementations, the applications 710 can include instructions that enable processor 702 to perform the functions described herein, e.g., in FIG. Software application 710 may include some or all of the functionality required to present interactive digital media. In some implementations, one or more portions of software application 710 may be implemented in dedicated hardware such as an application-specific integrated circuit (ASIC), a programmable logic device (PLD), a field-programmable gate array (FPGA), a machine learning processor, etc. In some implementations, one or more portions of software application 710 may be implemented in general purpose processors, such as a central processing unit (CPU) or a graphics processing unit (GPU). In various implementations, suitable combinations of dedicated and/or general purpose processing hardware may be used to implement software application 710.

For example, software application 710 stored in memory 704 can include instructions for retrieving user data, for displaying/presenting interactive digital media, and/or other functionality or software such as the media presentation component 130, VE Engine 104, and/or VE Application 112. Any of software in memory 704 can alternatively be stored on any other suitable storage location or computer-readable medium. In addition, memory 704 (and/or other connected storage device(s)) can store instructions and data used in the features described herein. Memory 704 and any other type of storage (magnetic disk, optical disk, magnetic tape, or other tangible media) can be considered “storage” or “storage devices.”

I/O interface 706 can provide functions to enable interfacing the server device 700 with other systems and devices. For example, network communication devices, storage devices (e.g., memory and/or data store 106), and input/output devices can communicate via interface 706. In some implementations, the I/O interface can connect to interface devices including input devices (keyboard, pointing device, touchscreen, microphone, camera, scanner, etc.) and/or output devices (display device, speaker devices, printer, motor, etc.).

For ease of illustration, FIG. 7 shows one block for each of processor 702, memory 704, I/O interface 706, software blocks 708 and 710, and database 712. These blocks may represent one or more processors or processing circuitries, operating systems, memories, I/O interfaces, applications, and/or software modules. In other implementations, device 700 may not have all of the components shown and/or may have other elements including other types of elements instead of, or in addition to, those shown herein. While the online server 102 are described as performing operations as described in some implementations herein, any suitable component or combination of components of online server 102, or similar system, or any suitable processor or processors associated with such a system, may perform the operations described.

A user device can implement and/or be used with features described herein. Example user devices can be computer devices including some similar components as the device 700, e.g., processor(s) 702, memory 704, and I/O interface 706. An operating system, software and applications suitable for the client device can be provided in memory and used by the processor. The I/O interface for a client device can be connected to network communication devices, as well as to input and output devices, e.g., a microphone for capturing sound, a camera for capturing images or video, audio speaker devices for outputting sound, a display device for outputting images or video, or other output devices. A display device within the audio/video input/output devices 714, for example, can be connected to (or included in) the device 700 to display images pre-and post-processing as described herein, where such display device can include any suitable display device, e.g., an LCD, LED, or plasma display screen, CRT, television, monitor, touchscreen, 3-D display screen, projector, or other visual display device. Some implementations can provide an audio output device, e.g., voice output or synthesis that speaks text.

The methods, blocks, and/or operations described herein can be performed in a different order than shown or described, and/or performed simultaneously (partially or completely) with other blocks or operations, where appropriate. Some blocks or operations can be performed for one portion of data and later performed again, e.g., for another portion of data. Not all of the described blocks and operations need be performed in various implementations. In some implementations, blocks and operations can be performed multiple times, in a different order, and/or at different times in the methods.

In some implementations, some or all of the methods can be implemented on a system such as one or more client devices. In some implementations, one or more methods described herein can be implemented, for example, on a server system, and/or on both a server system and a client system. In some implementations, different components of one or more servers and/or clients can perform different blocks, operations, or other parts of the methods.

One or more methods described herein (e.g., method 400 and/or method 500) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g. Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating system.

One or more methods described herein can be run in a standalone program that can be run on any type of computing device, a program run on a web browser, a mobile application (app) executing on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the live feedback data for output (e.g., for display). In another example, computations can be split between the mobile computing device and one or more server devices.

In situations in which certain implementations discussed herein may obtain or use user data (e.g., user demographics, user behavioral data, user contextual data, user settings for media, etc.) users are provided with options to control whether and how such information is collected, stored, or used. That is, the implementations discussed herein collect, store and/or use user information upon receiving explicit user authorization and in compliance with applicable regulations.

Users are provided with control over whether programs or features collect user information about that particular user or other users relevant to the program or feature. Each user for which information is to be collected is presented with options (e.g., via a user interface) to enable the user to exert control over the information collection relevant to that user, to provide permission or authorization as to whether the information is collected and as to which portions of the information are to be collected. In addition, certain data may be modified in one or more ways before storage or use, such that personally identifiable information is removed. As one example, an identity of the user may be modified (e.g., by substitution using a pseudonym, numeric value, etc.) so that no personally identifiable information can be determined. In another example, a geographic location of the user may be generalized to a larger region (e.g., city, zip code, state, country, etc.).

Although the description has been described with respect to particular implementations thereof, these particular implementations are merely illustrative, and not restrictive. Concepts illustrated in the examples may be applied to other examples and implementations.

Note that the functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer-implemented method to present media within a virtual experience provided by a virtual experience platform, the method comprising:
receiving media configured for display within the virtual experience, the media associated with a target demographic;
determining that one or more viewability criteria are satisfied based on a perspective of an avatar associated with a user relative to a digital media display element positioned within the virtual experience, wherein the user is associated with the target demographic;
determining, based on one or more level of interest criteria, that a level of interest of the user to view the media meets a threshold level;
in response to determining that the one or more viewability criteria are satisfied and determining that the level of interest meets the threshold level, initiating presentation of the media within the virtual experience by:
displaying video content of the media at the digital media display element; and
playing back mixed spatial audio, wherein the mixed spatial audio comprises at least audio content of the media and audio from the virtual experience;
providing interactive controls to modify the presentation of the media, the interactive controls comprising at least a full-screen activation control;
obtaining user input associated with the interactive controls and engagement by the avatar with the digital media display element; and
generating an engagement metric for the media based on the user input and the engagement by the avatar.

2. The computer-implemented method of claim 1, wherein the one or more level of interest criteria comprise one or more from the group comprising: a dwell time of the avatar within a proximity threshold of the digital media display element, a sustained orientation of the avatar or in-game camera toward the digital media display element, a raycast-based unobstructed line of sight to the digital media display element, a duration of screen-center alignment with the digital media display element, and any combination thereof.

3. The computer-implemented method of claim 1, wherein determining the level of interest of the user comprises evaluating a cumulative level of interest score computed from a plurality of level of interest criteria.

4. The computer-implemented method of claim 1, wherein prior to determining that the one or more viewability criteria are satisfied and determining the level of interest of the user to view the media, displaying a non-playing visual frame of the media in the digital media display element.

5. The computer-implemented method of claim 1, wherein presenting the media comprises initially rendering the video content in a muted state and enabling audio playback in response to detecting a user interaction with the digital media display element.

6. The computer-implemented method of claim 1, further comprising:
upon the full-screen activation control being triggered by user input, interpolating a virtual camera associated with the avatar toward the digital media display element while preserving peripheral visibility of the virtual experience.

7. The computer-implemented method of claim 1, further comprising:
after initiating presentation of the media within the virtual experience, detecting that at least one of the viewability criteria or the level of interest criteria is not satisfied; and
in response to the detecting, pausing playback of the media.

8. The computer-implemented method of claim 7, further comprising:
resuming playback of the video content when the at least one of the viewability criteria or the level of interest criteria is re-satisfied.

9. The computer-implemented method of claim 1, wherein generating the engagement metric for the media comprises measuring one or more from the group comprising: a total duration of playback, a completion status of the video content, one or more transitions between presentation modes, and any combination thereof.

10. The computer-implemented method of claim 1, further comprising:
granting a virtual reward to the user upon completion of playback of the media within the virtual experience and upon the engagement metric generated for the media meeting a predefined engagement threshold, wherein the virtual reward is specified by one of: a developer of the virtual experience, or a media provider associated with the media.

11. The computer-implemented method of claim 1, wherein the media comprises one or more from the group comprising: video content, still images, holographic content, special effects, animated visual elements, and combinations thereof.

12. The computer-implemented method of claim 1, further comprising:
applying access control rules to restrict display of the media based on one or more from the group comprising: one or more user attributes, an experience type of the virtual experience, one or more developer restrictions specified by a developer of the virtual experience, one or more media provider policies of a media provider associated with the media, and any combination thereof.

13. The computer-implemented method of claim 1, further comprising generating the mixed spatial audio by applying audio mixing logic to dynamically adjust, based on a media presentation mode, one or more properties of the audio content of the media and the audio from the virtual experience, wherein the one or more properties include audio volume levels, audio directionality, and combinations thereof.

14. The computer-implemented method of claim 13, wherein applying the audio mixing logic comprises dynamically lowering playback volume of in-game voice chat such that the playback volume of the in-game voice chat is lower than a playback volume of the audio associated with the video content.

15. A computing device comprising:
one or more processors; and
memory coupled to the one or more processors with instructions stored thereon that, when executed by the one or more processors, cause the one or more processors to perform operations comprising:
receiving media configured for display within the virtual experience, the media associated with a target demographic;
determining that one or more viewability criteria are satisfied based on a perspective of an avatar associated with a user relative to a digital media display element positioned within the virtual experience, wherein the user is associated with the target demographic;
determining, based on one or more level of interest criteria, that a level of interest of the user to view the media meets a threshold level;
in response to determining that the one or more viewability criteria are satisfied and determining that the level of interest meets the threshold level, initiating presentation of the media within the virtual experience by:
displaying video content of the media at the digital media display element; and
playing back mixed spatial audio, wherein the mixed spatial audio comprises at least audio content of the media and audio from the virtual experience;
providing interactive controls to modify the presentation of the media, the interactive controls comprising at least a full-screen activation control;
obtaining user input associated with the interactive controls and engagement by the avatar with the digital media display element; and
generating an engagement metric for the media based on the user input and the engagement by the avatar.

16. The computing device of claim 15, wherein the operations further comprise:
adjusting, based on the engagement metric, one or more parameters used to determine the level of interest of users in the media, wherein the adjusting comprises increasing or decreasing a weight assigned to one or more level of interest criteria for future users, thereby reducing resource usage by limiting presentation of media with low predicted engagement.

17. The computing device of claim 15, wherein the operations further comprise:
providing a reward to at least one of a creator of the virtual experience or a provider of the media based on the engagement metric meeting a predefined threshold.

18. The computing device of claim 15, wherein the media is associated with multiple target demographics, wherein generating the engagement metric comprises generating separate engagement metrics for each of the target demographics, and wherein the operations further comprise:
providing the separate engagement metrics as feedback to an entity associated with the media for evaluation of demographic-specific performance.

19. The computing device of claim 15, wherein the operations further comprise:
receiving a bid specification from a media provider, the bid specification defining one or more bidding conditions based on one or more from the group comprising: a bid per user predicted to have at least a threshold level of interest in the media based on the level of interest criteria, a bid per user determined to have at least a threshold level of engagement with the media based on the engagement metric, a bid per user who views the media for at least a specified duration, and any combination thereof.

20. A non-transitory computer-readable medium with instructions stored thereon that, when executed by a processor, cause the processor to perform operations comprising:
receiving media configured for display within the virtual experience, the media associated with a target demographic;
determining that one or more viewability criteria are satisfied based on a perspective of an avatar associated with a user relative to a digital media display element positioned within the virtual experience, wherein the user is associated with the target demographic;
determining, based on one or more level of interest criteria, that a level of interest of the user to view the media meets a threshold level;
in response to determining that the one or more viewability criteria are satisfied and determining that the level of interest meets the threshold level, initiating presentation of the media within the virtual experience by:
displaying video content of the media at the digital media display element; and
playing back mixed spatial audio, wherein the mixed spatial audio comprises at least audio content of the media and audio from the virtual experience;
providing interactive controls to modify the presentation of the media;
obtaining user input associated with the interactive controls and engagement by the avatar with the digital media display element; and
generating an engagement metric for the media based on the user input and the engagement by the avatar.
